(19) United States
(12) Patent Application Publication
(10) Pub. No.: US 2026/0196832 A1
(43) Pub. Date: Jul. 9, 2026

(54) SYSTEM AND METHOD FOR EXTENDING THE OPERATING SPEED THRESHOLD OF A GRID-FORMING INVERTER-BASED RESOURCE

(71) Applicant: General Electric Renovables España, S.L., Barcelona (ES)

(72) Inventors: Dustin Howard, Brookhaven, GA (US); Joseph Vincent Citeno, Greenville, SC (US)

(21) Appl. No.: 19/124,052

(22) PCT Filed: Oct. 28, 2022
(86) PCT No.: PCT/US2022/048238

§ 371 Date: Apr. 24, 2025

(51) Int. Cl. H02J 3/0014; H02J 101/28; H02M 1/00

(52) U.S. Cl. CPC H02J 3/00142; H02M 1/0025; H02J 2101/28

(57) ABSTRACT

A method of extending a predefined operating speed threshold of a grid-forming (GFM) inverter-based resource (IBR) connected to an electrical grid includes receiving a grid frequency signal of the electrical grid or a function thereof based on one or more grid frequency feedbacks. The method also includes determining a speed deviation based on the grid frequency signal of the electrical grid or the function thereof. Further, the method also includes combining the speed deviation with the predefined operating speed threshold of the GFM IBR, the predefined operating speed threshold of the GFM IBR being associated with a nominal grid frequency. Moreover, the method includes generating, via the controller, a new operating speed threshold for the GFM IBR using the speed deviation and the predefined operating speed threshold being associated with the nominal grid frequency. In addition, the method includes operating, via the controller, the GFM IBR using the new operating speed threshold.

### FIELD

The present disclosure relates generally to inverter-based resources, such as wind turbine power systems and, more particularly, to systems and methods for extending the operating speed threshold of a grid-forming inverter-based resource to prevent grid frequency-induced underspeed or overspeed trips.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. For example, rotor blades typically have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is typically geared to a generator for producing electricity.

Wind turbines can be distinguished in two types: fixed speed and variable speed turbines. Conventionally, variable speed wind turbines are controlled as current sources connected to a power grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency.

Thus, the wind turbines simply inject the specified current into the grid based on the fundamental voltage waveforms. However, with the rapid growth of the wind power, wind power penetration into some grids has increased to the point where wind turbine generators have a significant impact on the grid voltage and frequency. When wind turbines are located in a weak grid, wind turbine power fluctuations may lead to an increase in magnitude and frequency variations in the grid voltage. These fluctuations may adversely affect the performance and stability of the PLL and wind turbine current control.

Many existing renewable generation sources, such as double-fed wind turbine generators (WTGs), may operate in a “grid-following” mode and utilize fast current-regulation loops to control active and reactive power exchanged with the grid. More specifically, FIG. 1 illustrates the basic elements of the main circuit and converter control structure for a grid-following double-fed WTG. As shown, the active power reference to the converter is developed by the energy source regulator, e.g., the turbine control portion of a wind turbine, and is conveyed as a torque reference which represents the lesser of the maximum attainable power from the energy source at that instant, or a curtailment command from a higher-level grid controller. The converter control then determines a current reference for the active component of current to achieve the desired torque. Accordingly, the double-fed WTG includes functions that manage the voltage and reactive power in a manner that results in a command for the reactive component of current. Wide-bandwidth current regulators then develop commands for voltage to be applied by the converters to the system, such that the actual currents closely track the commands.

Alternatively, an inverter-based resource (IBR) (such as a double-fed WTG and controls) may operate under “grid-forming” (GFM) control wherein the IBR acts as a voltage source behind an impedance (primarily reactance) and provides a voltage-source characteristic, where the angle and magnitude of the voltage are controlled to achieve the regulation functions needed by the grid. In particular, the impedance of the IBR is normally dictated by the hardware of the system, such as reactors, transformers, or rotating machine impedances. With this structure, current will flow according to the demands of the grid, while the converter contributes to establishing a voltage and frequency for the grid. This characteristic is comparable to conventional generators based on a turbine driving a synchronous machine.

Thus, a GFM source desirably includes the following basic functions: (1) support grid voltage and frequency for any current flow within the rating of the equipment, both real and reactive; (2) prevent operation beyond equipment voltage or current capability by allowing grid voltage or frequency to change rather than disconnecting equipment (disconnection is allowed only when voltage or frequency are outside of bounds established by the grid entity); (3) remain stable for any grid configuration or load characteristic, including serving an isolated load or connected with other grid-forming sources, and switching between such configurations; (4) share total load of the grid among other grid-forming sources connected to the grid; (5) ride through grid disturbances, both major and minor, and (6) meet requirements (1)-(5) without requiring fast communication with other control systems existing in the grid, or externally-created logic signals related to grid configuration changes.

The basic control structure to achieve the above GFM objectives was developed and field-proven for battery systems in the early 1990's (see e.g., U.S. Pat. No. 5,798,633 entitled “Battery Energy Storage Power Conditioning System”). Applications to full-converter wind generators and solar generators are disclosed in U.S. Pat. No. 7,804,184 entitled “System and Method for Control of a Grid Connected Power Generating System,” and U.S. Pat. No. 9,270,194 entitled “Controller for controlling a power converter.” Applications to grid-forming control for a double-fed WTG are disclosed in PCT/US2020/013787 entitled “System and Method for Providing Grid-Forming Control for a Doubly-Feb Wind Turbine Generator.”

Accordingly, GFM WTGs are capable of important grid-supporting functions, including inertial power response and phase jump power response to grid frequency and phase angle changes, respectively. In addition, GFM WTGs are able to provide these functions by using the rotating kinetic energy stored within the wind turbine itself. These functions improve grid stability by changing active power output automatically in response to the load demands of the grid.

In certain instances, a consequence of providing these functions is that the energy used to support the grid stability changes the rotating speed of the WTG. For example, if the grid frequency decreases, the WTG responds by increasing power output, which slows down the rotor speed. If the WTG is operating at a relatively low speed upon occurrence of the drop in grid frequency, the WTG may trip on underspeed protection. A similar risk may exist for high speeds and grid over frequency.

In view of the foregoing, an improved system and method that addresses the aforementioned issue would be welcomed in the art.

### BRIEF DESCRIPTION

Aspects and advantages of the invention will be set forth in part in the following description, or may be obvious from the description, or may be learned through practice of the invention.

In an embodiment, the present disclosure is directed to a method of extending a predefined operating speed threshold of a grid-forming (GFM) inverter-based resource (IBR) connected to an electrical grid. The GFM IBR has a generator. The method includes receiving a grid frequency signal of the electrical grid or a function thereof based on one or more grid frequency feedbacks. The method also includes determining a speed deviation based on the grid frequency signal of the electrical grid or the function thereof. Further, the method also includes combining the speed deviation with the predefined operating speed threshold of the GFM IBR, the predefined operating speed threshold of the GFM IBR being associated with a nominal grid frequency. Moreover, the method includes generating, via the controller, a new operating speed threshold for the GFM IBR using the speed deviation and the predefined operating speed threshold being associated with the nominal grid frequency. In addition, the method includes operating, via the controller, the GFM IBR using the new operating speed threshold.

In another aspect, the present disclosure is directed to a method of preventing grid frequency-induced trips of a grid-forming (GFM) inverter-based resource (IBR) connected to an electrical grid. The GFM IBR has a generator. The method includes determining, via a controller, a rate of change of a grid frequency of the electrical grid based on one or more grid frequency feedbacks. The method also includes comparing, via the controller, the rate of change of the grid frequency to a predetermined threshold. Further, the method includes temporarily increasing, via the controller, a standard speed-related trip level of the GFM IBR to a modified trip level for a certain time period when the rate of change of the grid frequency is greater than the predetermined threshold indicative of a grid-induced power change, wherein, by temporarily increasing the standard speed-related trip level for the certain time period, the GFM IBR has enough time to recover from the grid-induced power change and resume normal operation.

In yet another aspect, the present disclosure is directed to a wind turbine power system connected to an electrical grid. The wind turbine power system includes a tower, a nacelle mounted atop the tower, a rotor having a rotatable hub with at least one rotor blade, and a controller for controlling the wind turbine power system. The controller includes at least one processor configured to perform a plurality of operations, including but not limited to determining a rate of change of a grid frequency of the electrical grid based on one or more grid frequency feedbacks, comparing the rate of change of the grid frequency to a predetermined range indicative of a grid-induced power change of a certain amount, and temporarily reducing a standard speed-related trip level of the wind turbine power system to a modified trip level for a certain time period when the rate of change of the grid frequency is outside of the predetermined range, wherein, by temporarily reducing the standard speed-related trip level for the certain time period, the wind turbine power system has enough time to recover from the grid-induced power change and resume normal operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a one-line diagram of a double-fed wind turbine generator with structure of converter controls for grid-following application according to conventional construction;

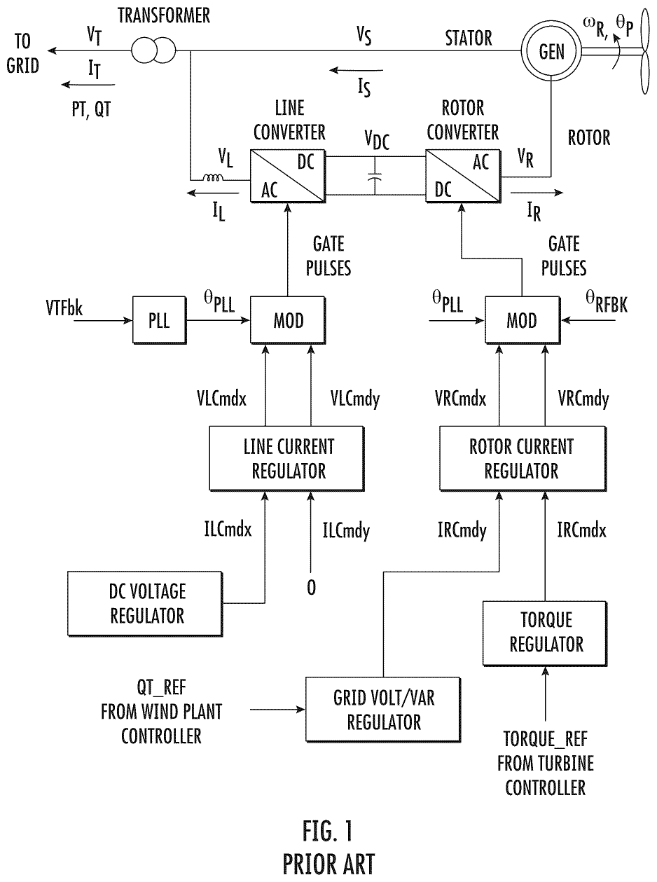

FIG. 2 illustrates a perspective view of one embodiment of a wind turbine according to the present disclosure;

FIG. 3 illustrates a schematic view of one embodiment of a wind turbine electrical power system suitable for use with the wind turbine shown in FIG. 1;

FIG. 4 illustrates a block diagram of one embodiment of a controller according to the present disclosure;

FIG. 5 illustrates a control diagram of one embodiment of system for providing grid-forming control of an inverter-based resource according to the present disclosure;

FIG. 6 illustrates a flow diagram of an embodiment of a method for extending the operating speed threshold of a grid-forming inverter-based resource connected to an electrical grid according to the present disclosure;

FIG. 7 illustrates a flow diagram of an embodiment of an algorithm for extending the operating speed threshold of a grid-forming inverter-based resource connected to an electrical grid according to the present disclosure;

FIG. 8 illustrates a flow diagram of another embodiment of a method for extending the operating speed threshold of a grid-forming inverter-based resource connected to an electrical grid according to the present disclosure; and

FIG. 9 illustrates a schematic diagram of an embodiment of an implementation for extending the operating speed threshold of a grid-forming inverter-based resource connected to an electrical grid according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, some types of IBRs with rotating generators have an operating speed threshold. As an example, in a dual-fed type IBR, this operating speed threshold may be determined based on the voltage ratings of the rotor-side converter, where the voltage on the rotor is roughly proportional to the operating slip of the machine, given by Equation (1) below:

$$slip = ( w s - wr ) / ws \qquad Equation ( 1 )$$

where ws is the grid frequency and wr is the rotor speed.

This equation shows that the farther the rotor speed deviates from the frequency of the grid, the larger the slip (and thus the larger the rotor voltage). For this reason, the operating speed threshold of the IBR must be constrained to avoid excessive voltages on the rotor-side converter. However, the slip is also impacted by the grid frequency, and therefore the range of operating speeds may be adjusted under off-nominal grid frequency conditions while not adversely impacting the rotor-side converter. Adjusting the operating speed capabilities of the IBR in this way would be beneficial to the grid because the IBR may be able to stay online and support the grid instead of tripping/disconnecting due to excessively low or high operating speed.

In general, the present disclosure is directed to systems and methods for extending the operating speed threshold of a grid-forming (GFM) inverter-based resource (IBR) connected to an electrical grid. In particular, the method includes determining a rate of change of a grid frequency of the electrical grid based on one or more grid frequency feedbacks and comparing the rate of change of the grid frequency to a predetermined range indicative of a grid-induced power change of a certain amount. The method further includes temporarily reducing a standard speed-related trip level of the IBR to a modified trip level for a certain time period when the rate of change of the grid frequency is outside of the predetermined range. By temporarily reducing the standard speed-related trip level for the certain time period, the IBR has enough time to recover from the grid-induced power change and resume normal operation. Accordingly, systems and methods of the present invention temporarily widen or extend under/over speed trip thresholds of the IBR in response to grid-induced power changes to reduce the risk of over/under speed trips. As used herein, the term “inverter-based resource (IBR)” used herein is a term of art and is generally understood to mean renewable generation energy sources (e.g., wind, solar, and energy storage power plants) that are asynchronously connected to the electrical grid completely or partially through power electronic inverters.

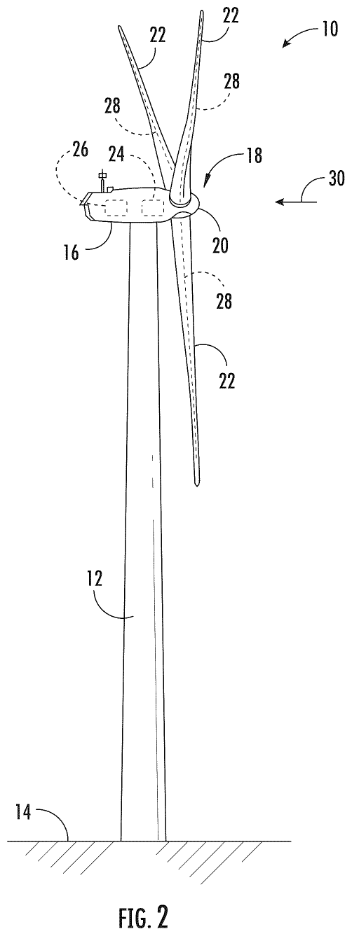

Referring now to the drawings, FIG. 2 illustrates a perspective view of one embodiment of a wind turbine 10 according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 positioned within the nacelle 16 to permit electrical energy to be produced.

The wind turbine 10 may also include a wind turbine controller 26 centralized within the nacelle 16. However, in other embodiments, the controller 26 may be located within any other component of the wind turbine 10 or at a location outside the wind turbine 10. Further, the controller 26 may be communicatively coupled to any number of the components of the wind turbine 10 in order to control the operation of such components and/or implement a corrective or control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. Accordingly, the controller 26 may generally be configured to control the various operating modes (e.g., start-up or shut-down sequences), de-rating or up-rating the wind turbine, and/or individual components of the wind turbine 10.

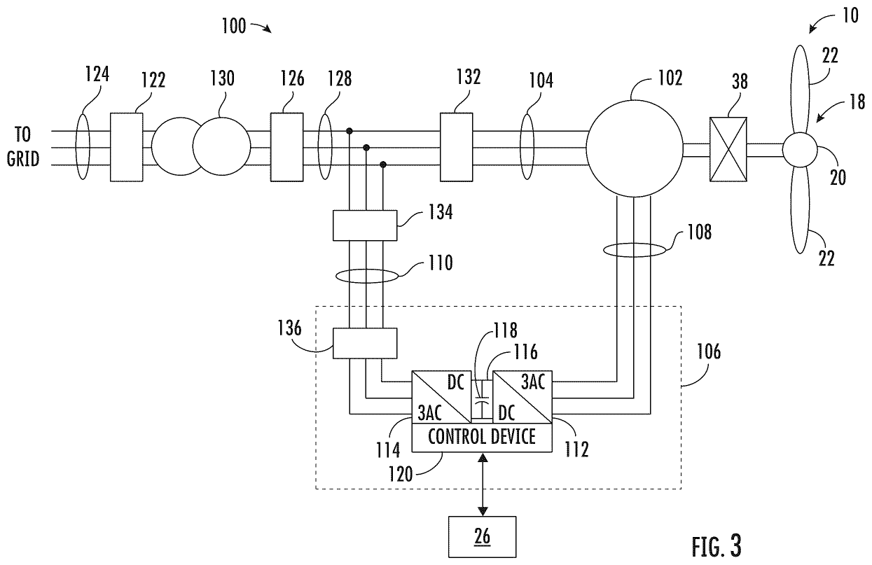

Referring now to FIG. 3, a schematic diagram of one embodiment of an inverter-based resource, such as a wind turbine power system 100, is illustrated in accordance with aspects of the present disclosure. Although the present disclosure will generally be described herein with reference to the wind turbine 10 shown in

FIG. 3, those of ordinary skill in the art, using the disclosures provided herein, should understand that aspects of the present disclosure may also be applicable in other power generation systems, and, as mentioned above, that the invention is not limited to wind turbine systems.

In the embodiment of FIG. 3 and as mentioned, the rotor 18 of the wind turbine 10 (FIG. 2) may, optionally, be coupled to the gearbox 38, which is, in turn, coupled to a generator 102, which may be a doubly fed induction generator (DFIG). The DFIG 102 may be connected to a stator bus 104 and a converter 106 may be connected to the DFIG 102 via a rotor bus 108, and to the stator bus 104 via a line side bus 110. As such, the stator bus 104 may provide an output multiphase power (e.g., three-phase power) from a stator of the DFIG 102, and the rotor bus 108 may provide an output multiphase power (e.g., three-phase power) from a rotor of the DFIG 102. The power converter 106 may also include a rotor side converter (RSC) 112 and a line side converter (LSC) 114. The DFIG 102 is coupled via the rotor bus 108 to the rotor side converter 112. Additionally, the RSC 112 is coupled to the LSC 114 via a DC link 116 across which is a DC link capacitor 118. The LSC 114 is, in turn, coupled to the line side bus 110.

The RSC 112 and the LSC 114 may be configured for normal operating mode in a three-phase, pulse width modulation (PWM) arrangement using one or more switching devices, such as insulated gate bipolar transistor (IGBT) switching elements. In addition, the power converter 106 may be coupled to a converter controller 120 in order to control the operation of the rotor side converter 112 and/or the line side converter 114 as described herein. It should be noted that the converter controller 120 may be configured as an interface between the power converter 106 and the turbine controller 26 and may include any number of control devices.

In typical configurations, various line contactors and circuit breakers including, for example, a grid breaker 122 may also be included for isolating the various components as necessary for normal operation of the DFIG 102 during connection to and disconnection from a load, such as the electrical grid 124. For example, a system circuit breaker 126 may couple a system bus 128 to a transformer 130, which may be coupled to the electrical grid 124 via the grid breaker 122. In alternative embodiments, fuses may replace some or all of the circuit breakers.

In operation, alternating current power generated at the DFIG 102 by rotating the rotor 18 is provided to the electrical grid 124 via dual paths defined by the stator bus 104 and the rotor bus 108. On the rotor bus side 108, sinusoidal multi-phase (e.g., three-phase) alternating current (AC) power is provided to the power converter 106. The rotor side converter 112 converts the AC power provided from the rotor bus 108 into direct current (DC) power and provides the DC power to the DC link 116. As is generally understood, switching elements (e.g., IGBTs) used in the bridge circuits of the rotor side converter 112 may be modulated to convert the AC power provided from the rotor bus 108 into DC power suitable for the DC link 116.

In addition, the line side converter 114 converts the DC power on the DC link 116 into AC output power suitable for the electrical grid 124. In particular, switching elements (e.g., IGBTs) used in bridge circuits of the line side converter 114 can be modulated to convert the DC power on the DC link 116 into AC power on the line side bus 110. The AC power from the power converter 106 can be combined with the power from the stator of DFIG 102 to provide multi-phase power (e.g., three-phase power) having a frequency maintained substantially at the frequency of the electrical grid 124 (e.g., 50 Hz or 60 Hz).

Additionally, various circuit breakers and switches, such as grid breaker 122, system breaker 126, stator sync switch 132, converter breaker 134, and line contactor 136 may be included in the wind turbine power system 100 to connect or disconnect corresponding buses, for example, when current flow is excessive and may damage components of the wind turbine power system 100 or for other operational considerations. Additional protection components may also be included in the wind turbine power system 100.

Moreover, the power converter 106 may receive control signals from, for instance, the controller 26 via the converter controller 120. The control signals may be based, among other things, on sensed states or operating characteristics of the wind turbine power system 100. Typically, the control signals provide for control of the operation of the power converter 106. For example, feedback in the form of a sensed speed of the DFIG 102 may be used to control the conversion of the output power from the rotor bus 108 to maintain a proper and balanced multi-phase (e.g., three-phase) power supply. Other feedback from other sensors may also be used by the controller(s) 120, 26 to control the power converter 106, including, for example, stator and rotor bus voltages and current feedbacks. Using the various forms of feedback information, switching control signals (e.g., gate timing commands for IGBTs), stator synchronizing control signals, and circuit breaker signals may be generated.

The power converter 106 also compensates or adjusts the frequency of the three-phase power from the rotor for changes, for example, in the wind speed at the hub 20 and the rotor blades 22. Therefore, mechanical and electrical rotor frequencies are decoupled and the electrical stator and rotor frequency matching is facilitated substantially independently of the mechanical rotor speed.

Under some states, the bi-directional characteristics of the power converter 106, and specifically, the bi-directional characteristics of the LSC 114 and RSC 112, facilitate feeding back at least some of the generated electrical power into generator rotor. More specifically, electrical power may be transmitted from the stator bus 104 to the line side bus 110 and subsequently through the line contactor 136 and into the power converter 106, specifically the LSC 114 which acts as a rectifier and rectifies the sinusoidal, three-phase AC power to DC power. The DC power is transmitted into the DC link 116. The capacitor 118 facilitates mitigating DC link voltage amplitude variations by facilitating mitigation of a DC ripple sometimes associated with three-phase AC rectification.

The DC power is subsequently transmitted to the RSC 112 that converts the DC electrical power to a three-phase, sinusoidal AC electrical power by adjusting voltages, currents, and frequencies. This conversion is monitored and controlled via the converter controller 120. The converted AC power is transmitted from the RSC 112 via the rotor bus 108 to the generator rotor. In this manner, generator reactive power control is facilitated by controlling rotor current and voltage.

The wind turbine power system 100 described herein may be part of a wind farm that includes a plurality of wind turbines, such as the wind turbine 10 described above, and an overall farm-level controller. The individual turbine controllers of the plurality of wind turbines are communicatively coupled to the farm-level controller, e.g., through a wired connection, such as by connecting the turbine controller 26 through suitable communicative links (cable or wireless). The farm-level controller is configured to send and receive control signals to and from the various wind turbines, such as for example, distributing real and/or reactive power demands across the wind turbines of the wind farm.

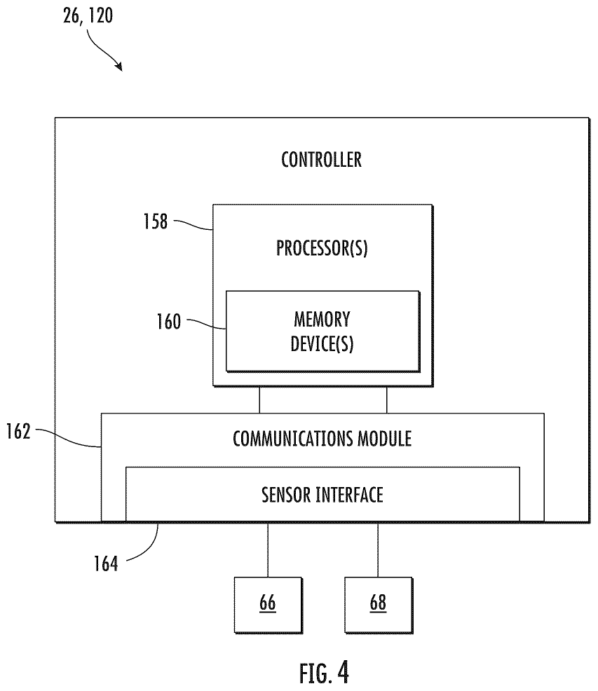

Referring now to FIG. 4, a block diagram of one embodiment of suitable components that may be included within the controller (such as any one of the converter controller 120, the turbine controller 26, and/or the farm-level controller described herein) in accordance with example aspects of the present disclosure is illustrated. As shown, the controller may include one or more processor(s) 58, computer, or other suitable processing unit and associated memory device(s) 60 that may include suitable computer-readable instructions that, when implemented, configure the controller to perform various different functions, such as receiving, transmitting and/or executing wind turbine control signals (e.g., performing the methods, steps, calculations, and the like disclosed herein).

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 60 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

Such memory device(s) 60 may generally be configured to store suitable computer-readable instructions that, when implemented by the processor(s) 58, configure the controller to perform various functions as described herein. Additionally, the controller may also include a communications interface 62 to facilitate communications between the controller and the various components of the wind turbine 10. An interface can include one or more circuits, terminals, pins, contacts, conductors, or other components for sending and receiving control signals. Moreover, the controller may include a sensor interface 64 (e.g., one or more analog-to-digital converters) to permit signals transmitted from the sensors 66, 68 to be converted into signals that can be understood and processed by the processor(s) 58.

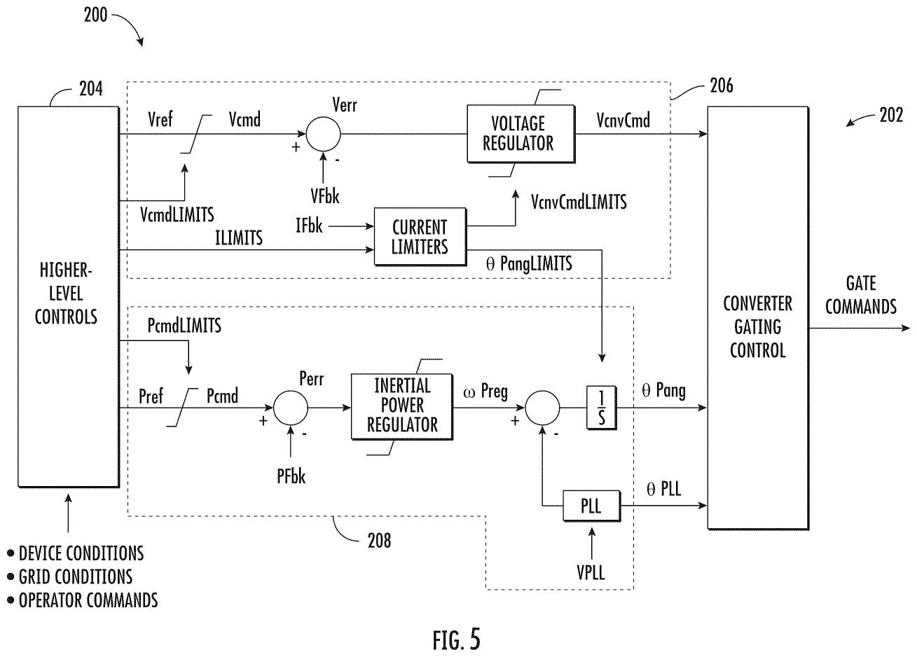

Referring now to FIG. 5, a control diagram of a system 200 for providing grid-forming (GFM) control according to aspects of the present methods and systems is illustrated. As shown, the converter controller 202 receives references (e.g., Vref and Pref) and limits (e.g., VcmdLimits and PcmdLimits) from higher-level controls 204. The high-level controls 204 place limits on physical quantities of voltage, current, and power. The main regulators include a fast voltage regulator 206 and a slow power regulator 208. These regulators 206, 208 have final limits applied to the converter control commands for voltage magnitude (e.g., VcnvCmd) and angle (e.g., θPang and θPLL) from the phase-locked loop (PLL) to implement constraints on reactive- and real-components of current, respectively. Further, such limits are based upon a pre-determined fixed value as a default, with closed-loop control to reduce the limits should current exceed limits.

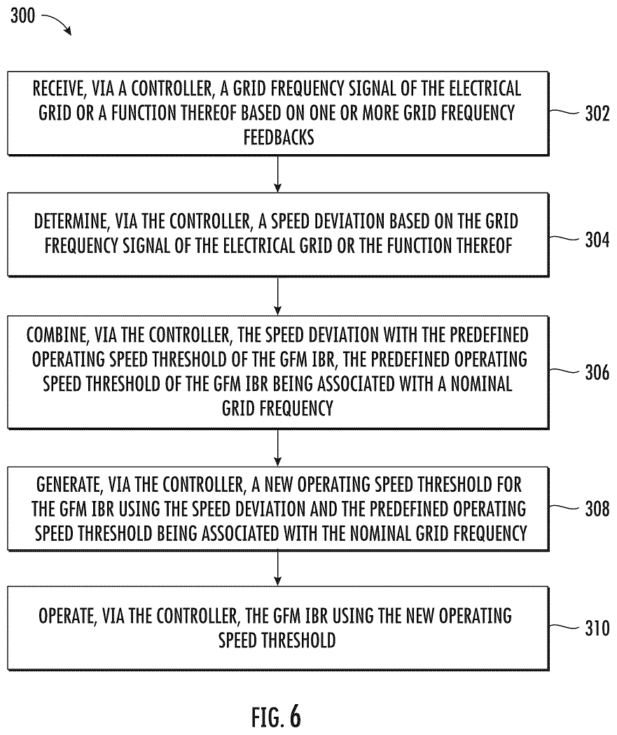

Referring now to FIG. 6, a flow diagram of an embodiment of a method 300 of extending a predefined operating speed threshold of a grid-forming (GFM) inverter-based resource (IBR) connected to an electrical grid is illustrated. It should be appreciated that the method 300 is discussed herein only to describe aspects of the present disclosure and is not intended to be limiting. Further, though FIG. 6 depicts the method 300 having steps performed in a particular order for purposes of illustration and discussion, those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained with respect to the system 200 for providing GFM control of FIG. 5, as an example, it should be appreciated that these methods may be applied to the operation of any suitable power system having one or more IBRs.

In particular, as shown at (302), the method 300 includes receiving, via a controller, a grid frequency signal of the electrical grid or a function thereof based on one or more grid frequency feedbacks. For example, in an embodiment, the grid frequency signal of the electrical grid or the function thereof may be a rate of change of the grid frequency. As shown at (304), the method 300 includes determining, via the controller, a speed deviation based on the grid frequency signal of the electrical grid or the function thereof. As shown at (306), the method 300 includes combining, via the controller, the speed deviation with a predefined operating speed threshold of the GFM IBR, the predefined operating speed threshold of the GFM IBR being associated with a nominal grid frequency. As shown at (308), the method 300 includes generating, via the controller, a new operating speed threshold for the GFM IBR using the speed deviation and the predefined operating speed threshold being associated with the nominal grid frequency. As shown at (310), the method 300 includes operating, via the controller, the GFM IBR using the new operating speed threshold. Thus, in an embodiment, extending the operating speed threshold may include temporarily reducing a lower speed-related trip threshold of the GFM IBR by a pre-determined speed deviation.

In a particular embodiment, the method 300 may include determining, via a controller, a rate of change of a grid frequency of the electrical grid based on one or more grid frequency feedbacks. Further, the method 300 may include comparing, via the controller, the rate of change of the grid frequency to a predetermined threshold. Further, the method 300 may include temporarily increasing, via the controller, a standard speed-related trip level of the GFM IBR to a modified trip level for a certain time period when the rate of change of the grid frequency is greater than the predetermined threshold indicative of a grid-induced power change. Accordingly, by temporarily increasing the standard speed-related trip level for the certain time period, the GFM IBR has enough time to recover from the grid-induced power change and resume normal operation.

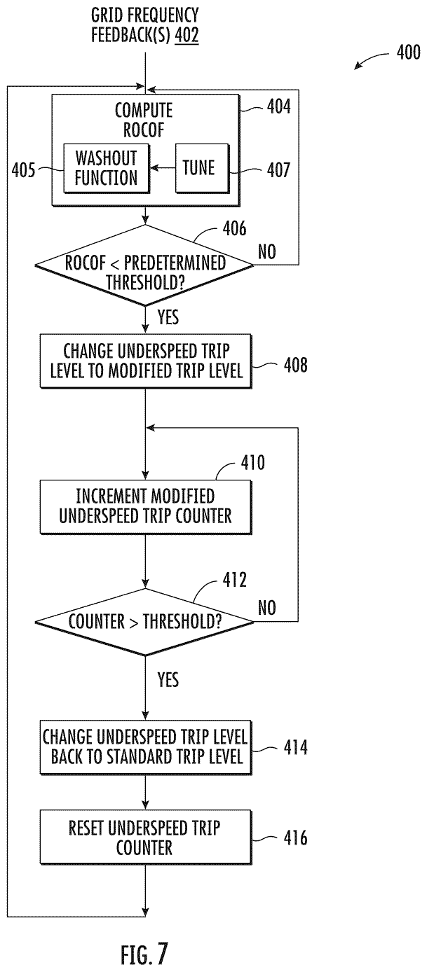

The method 300 of FIG. 6 can be better understood with reference to the algorithm 400 illustrated in FIG. 7, as an example. In particular, as shown, the algorithm 400 of FIG. 7 generally applies to underspeed conditions and an underspeed trip level caused by grid under-frequency events. In further embodiments, it should be understood that algorithms of the present disclosure can also be applied to overspeed conditions and an overspeed trip level caused by grid over-frequency events.

Accordingly, as shown, the algorithm 400 receives one or more grid frequency feedbacks 402. In certain embodiments, the algorithm 400 may include estimating the grid frequency feedback(s) using the PLL of the GFM IBR and/or local feedback voltages. Thus, as shown at 404, the algorithm 400 includes computing a rate of change of the grid frequency (ROCOF) of the electrical grid based on one or more grid frequency feedbacks. In an embodiment, for example, the algorithm 400 may include utilizing a washout function 405 to determine the ROCOF based on the one or more grid frequency feedbacks 402. In such embodiments, as shown at 407, the algorithm 400 may further include tuning the washout function 405 to filter out noise but to retain enough bandwidth for an intended level of the ROCOF.

Still referring to FIG. 7, as shown at 406, the algorithm 400 further includes comparing the ROCOF to a predetermined threshold. For example, in an embodiment, the predetermined threshold may range from about −0.1 Hertz per second (Hz/s) to about −1.0 Hz/s. In another embodiment, the predetermined threshold may be less than −1.0 Hz/s. If the ROCOF is greater than the predetermined threshold, the algorithm 400 starts over. If the ROCOF is less than the predetermined threshold, the algorithm 400 continues at 408. In particular, as shown at 408, the algorithm 400 includes changing or modifying the underspeed trip level by a pre-determined speed deviation amount to a modified trip level. In certain embodiments, the speed deviation amount may be, for example, 30 rotations per minute (RPM) and the speed trip level associated with nominal grid frequency may be, for example, 800 RPM, thereby making the modified underspeed trip level 770 RPM.

Moreover, as shown at 410, the algorithm 400 may include utilizing (e.g., incrementing) a modified underspeed trip counter to track a time period that the modified trip level is active. Thus, as shown at 412, the counter can be compared to a threshold. If the counter is below the threshold, the algorithm 400 continues to run the counter. If the counter is above the threshold, as shown at 414, the algorithm 400 is configured to change the underspeed tip level back to the standard speed-related trip level (e.g., by increasing the modified trip level back to the standard speed-related trip level when the time period exceeds a certain time frame). In such embodiments, as an example, the certain time may range from about 5 seconds to about 30 seconds. Furthermore, as shown at 416, the algorithm 400 may reset the underspeed trip counter and start over.

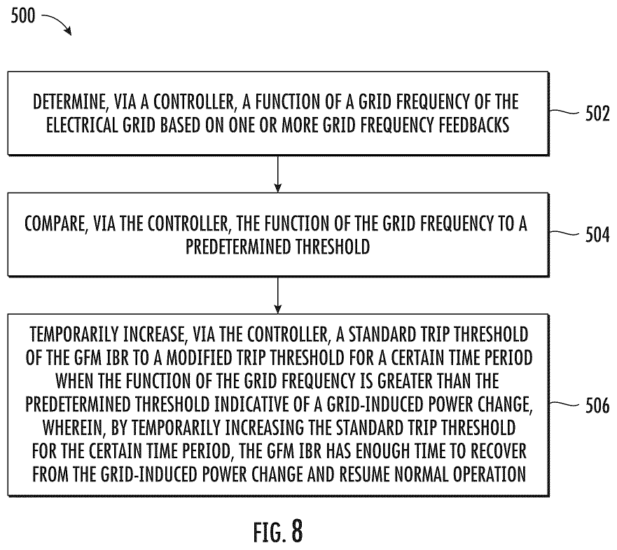

Referring now to FIG. 8, a flow diagram of another embodiment of a method 500 of extending an operating speed threshold of a GFM IBR connected to an electrical grid is illustrated. In contrast to the method 300 of FIG. 6 that applies to underspeed conditions and an underspeed trip level caused by grid under-frequency events, however, the method 500 of FIG. 8 generally applies to overspeed conditions and an overspeed trip level caused by grid over-frequency events. Moreover, it should be appreciated that the method 500 is discussed herein only to describe aspects of the present disclosure and is not intended to be limiting. Further, though FIG. 8 depicts the method 500 having steps performed in a particular order for purposes of illustration and discussion, those of ordinary skill in the art, using the disclosures provided herein, will understand that the steps of any of the methods discussed herein can be adapted, rearranged, expanded, omitted, or modified in various ways without deviating from the scope of the present disclosure.

In particular, as shown at (502), the method 500 includes determining, via a controller, a rate of change of a grid frequency of the electrical grid based on one or more grid frequency feedbacks. As shown at (504), the method 500 includes comparing, via the controller, the rate of change of the grid frequency to a predetermined threshold. As shown at (506), the method 500 includes temporarily increasing, via the controller, a standard speed-related trip level of the GFM IBR to a modified trip level for a certain time period when the rate of change of the grid frequency is greater than the predetermined threshold indicative of a grid-induced power change. Thus, by temporarily increasing the standard speed-related trip level for the certain time period, the GFM IBR has enough time to recover from the grid-induced power change and resume normal operation.

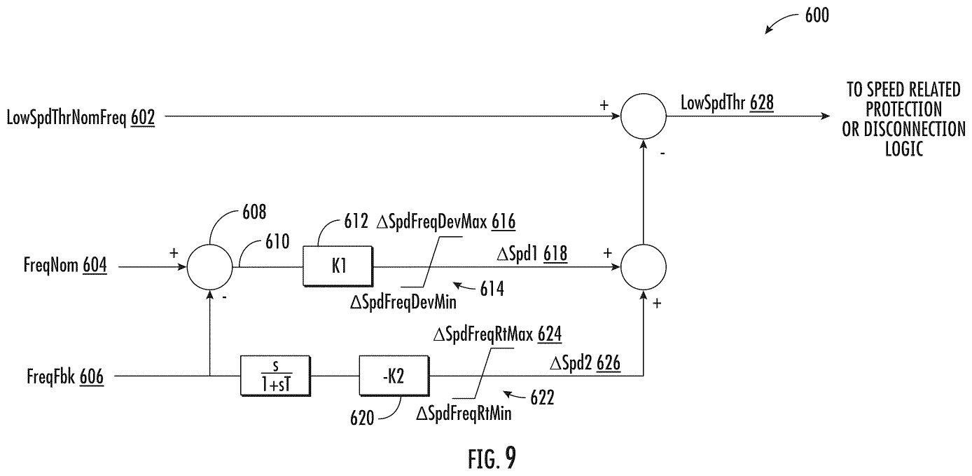

Referring now to FIG. 9, a schematic diagram of an embodiment of a system 600 for preventing grid frequency-induced trips of a grid-forming inverter-based resource connected to an electrical grid according to the present disclosure is illustrated. More specifically, as shown, the system 600 is configured to receive a lower speed threshold associated with a nominal grid frequency 602 (e.g., LowSpdThrNomFreq), a nominal grid frequency 604 (e.g., FreqNom) and a grid frequency feedback 606 (e.g., FreqFbk). Further, as shown at 608, the grid frequency feedback 606 can be subtracted from the nominal grid frequency 604. An output 610 from the summator 608 can then be further processed, e.g., by applying a gain 612 and/or a limiter 614. The limiter 614, for example, may apply a predetermined maximum level 616 (e.g., ΔSpdFreqDev) that the speed threshold may be reduced due to deviations in grid frequency. Thus, an output 618 (e.g., ΔSpd1) of the limiter 614 represents a speed deviation that is proportional to the deviation in grid frequency from nominal frequency.

Moreover, as shown, the grid frequency feedback 606 may also be further processed, e.g., by applying a gain 620 and/or a limiter 622. In an embodiment, for example, K1 and K2 represent predetermined gains related frequency deviation/rate of change of frequency to change in speed threshold. In addition, the limiter 622, for example, may apply a predetermined maximum level 624 (e.g., ΔSpdFreqRt) that the speed threshold may be reduced due to rate of change of grid frequency. In particular, as shown, an output 626 (e.g., ΔSpd2) of the limiter 622 represents a speed deviation that is proportional to the rate of change of grid frequency. Thus, the system 600 is further configured to determine a new lower speed threshold 628 (e.g., LowSpdThr) as a function of a pre-determined lower speed threshold associated with nominal grid frequency 602, the nominal grid frequency 604, and the grid frequency feedback 606. In such embodiments, the new lower speed threshold 628 can be used to disconnect/trip the GFM IBR from the electrical grid.

Accordingly, in an embodiment, the present disclosure allows for deviating the speed threshold associated with the nominal grid frequency 602 (e.g., LowSpdThrNomFreq) in proportion to the deviation (e.g., ΔSpd1 618) in grid frequency from nominal. Moreover, the present disclosure allows for deviating the speed threshold associated with the nominal grid frequency 602 in proportion to the rate of change of grid frequency (e.g., ΔSpd2 626). By deviating the speed threshold associated with nominal grid frequency in this way, the IBR is able to have extended operating speed threshold that is wider when grid frequency deviates from nominal while still avoiding overvoltages on the rotor (in the case of a dual-fed type IBR).

Various aspects and embodiments of the present invention are defined by the following numbered clauses:

A method of extending a predefined operating speed threshold of a grid-forming (GFM) inverter-based resource (IBR) connected to an electrical grid, the GFM IBR having a generator, the method comprising: receiving, via a controller, a grid frequency signal of the electrical grid or a function thereof based on one or more grid frequency feedbacks; determining, via the controller, a speed deviation based on the grid frequency signal of the electrical grid or the function thereof; combining, via the controller, the speed deviation with the predefined operating speed threshold of the GFM IBR, the predefined operating speed threshold of the GFM IBR being associated with a nominal grid frequency; generating, via the controller, a new operating speed threshold for the GFM IBR using the speed deviation and the predefined operating speed threshold being associated with the nominal grid frequency; and operating, via the controller, the GFM IBR using the new operating speed threshold.

The method of any preceding clause, wherein the grid frequency signal of the electrical grid or the function thereof comprises a grid frequency or a rate of change of the grid frequency.

The method of any preceding clause, further comprising deviating the predefined operating speed threshold associated with the nominal grid frequency in proportion to a deviation in the grid frequency from the nominal grid frequency.

The method of any preceding clause, further comprising deviating the predefined operating speed threshold associated with the nominal grid frequency in proportion to the rate of change of the grid frequency.

The method of any preceding clause, further comprising utilizing a washout function to determine the rate of change of the grid frequency signal of the electrical grid based on the one or more grid frequency feedbacks.

The method of any preceding clause, further comprising tuning the washout function to filter out noise while retaining enough bandwidth for an intended level of the grid frequency signal of the electrical grid or the function thereof.

The method of any preceding clause, further comprising comparing, via the controller, the grid frequency signal of the electrical grid or the function thereof to a predetermined threshold indicative of a grid-induced power change.

The method of any preceding clause, wherein generating the new operating speed threshold for the GFM IBR using the combined grid frequency signal of the electrical grid or the function thereof and the predefined operating speed threshold having the fixed frequency further comprises: temporarily reducing, via the controller, a standard speed-related trip level of the GFM IBR to a modified trip level for a certain time period when the grid frequency signal of the electrical grid or a function thereof is less than the predetermined threshold indicative of the grid-induced power change, wherein, by temporarily reducing the standard speed-related trip level for the certain time period, the GFM IBR has enough time to recover from the grid-induced power change and resume normal operation.

The method of any preceding clause, wherein the predetermined threshold ranges from about −0.1 Hertz per second (Hz/s) to about −1.0 Hz/s.

The method of any preceding clause, wherein the predetermined threshold is less than −1.0 Hz/s.

The method of any preceding clause, further comprising utilizing a trip counter to track a time period that the modified trip level is active.

The method of any preceding clause, further comprising increasing the modified trip level back to the standard speed-related trip level when the time period exceeds a certain time.

The method of any preceding clause, wherein the certain time ranges from about 5 seconds to about 30 seconds.

The method of any preceding clause, further comprising estimating the one or more grid frequency feedbacks using a phase-locked loop (PLL) of the GFM IBR and local feedback voltages.

The method of any preceding clause, wherein the GFM IBR is a double-fed or full-power conversion wind turbine generator in a wind turbine power system connected to the electrical grid, the double-fed wind turbine generator coupled to a power converter having a line-side converter and a rotor-side converter coupled together via a DC link.

A method of preventing grid frequency-induced trips of a grid-forming (GFM) inverter-based resource (IBR) connected to an electrical grid, the GFM IBR having a generator, the method comprising: determining, via a controller, a rate of change of a grid frequency of the electrical grid based on one or more grid frequency feedbacks; comparing, via the controller, the rate of change of the grid frequency to a predetermined threshold; and temporarily increasing, via the controller, a standard speed-related trip level of the GFM IBR to a modified trip level for a certain time period when the rate of change of the grid frequency is greater than the predetermined threshold indicative of a grid-induced power change, wherein, by temporarily increasing the standard speed-related trip level for the certain time period, the GFM IBR has enough time to recover from the grid-induced power change and resume normal operation.

The method of any preceding clause, further comprising estimating the one or more grid frequency feedbacks using a phase-locked loop (PLL) of the GFM IBR and local feedback voltages.

The method of any preceding clause, wherein determining the function of the grid frequency of the electrical grid based on the one or more grid frequency feedbacks further comprises: utilizing a washout function to determine the rate of change of the grid frequency of the electrical grid based on the one or more grid frequency feedbacks; and tuning the washout function to filter out noise but to retain enough bandwidth for an intended level of the rate of change of the grid frequency.

The method of any preceding clause, further comprising: utilizing a trip counter to track a time period that the modified trip level is active; and increasing the modified trip level back to the standard speed-related trip level when the time period exceeds a certain time.

A wind turbine power system connected to an electrical grid, comprising: a tower; a nacelle mounted atop the tower; a rotor comprising a rotatable hub with at least one rotor blade; a controller for controlling the wind turbine power system, the controller comprising at least one processor, the at least one processor configured to perform a plurality of operations, the plurality of operations comprising: determining a rate of change of a grid frequency of the electrical grid based on one or more grid frequency feedbacks; comparing the rate of change of the grid frequency to a predetermined range indicative of a grid-induced power change of a certain amount; and temporarily reducing a standard speed-related trip level of the wind turbine power system to a modified trip level for a certain time period when the rate of change of the grid frequency is outside of the predetermined range, wherein, by temporarily reducing the standard speed-related trip level for the certain time period, the wind turbine power system has enough time to recover from the grid-induced power change and resume normal operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of extending a predefined operating speed threshold of a grid-forming (GFM) inverter-based resource (IBR) connected to an electrical grid, the GFM IBR having a generator, the method comprising:
receiving, via a controller, a grid frequency signal of the electrical grid or a function thereof based on one or more grid frequency feedbacks;
determining, via the controller, a speed deviation based on the grid frequency signal of the electrical grid or the function thereof;
combining, via the controller, the speed deviation with the predefined operating speed threshold of the GFM IBR, the predefined operating speed threshold of the GFM IBR being associated with a nominal grid frequency;
generating, via the controller, a new operating speed threshold for the GFM IBR using the speed deviation and the predefined operating speed threshold being associated with the nominal grid frequency; and
operating, via the controller, the GFM IBR using the new operating speed threshold.

2. The method of claim 1, wherein the grid frequency signal of the electrical grid or the function thereof comprises a grid frequency or a rate of change of the grid frequency.

3. The method of claim 2, further comprising deviating the predefined operating speed threshold associated with the nominal grid frequency in proportion to a deviation in the grid frequency from the nominal grid frequency.

4. The method of claim 2, further comprising deviating the predefined operating speed threshold associated with the nominal grid frequency in proportion to the rate of change of the grid frequency.

5. The method of claim 2, further comprising utilizing a washout function to determine the rate of change of the grid frequency signal of the electrical grid based on the one or more grid frequency feedbacks.

6. The method of claim 5, further comprising tuning the washout function to filter out noise while retaining enough bandwidth for an intended level of the grid frequency signal of the electrical grid or the function thereof.

7. The method of claim 1, further comprising comparing, via the controller, the grid frequency signal of the electrical grid or the function thereof to a predetermined threshold indicative of a grid-induced power change.

8. The method of claim 7, wherein generating the new operating speed threshold for the GFM IBR using the combined grid frequency signal of the electrical grid or the function thereof and the predefined operating speed threshold having the fixed frequency further comprises:
temporarily reducing, via the controller, a standard speed-related trip level of the GFM IBR to a modified trip level for a certain time period when the grid frequency signal of the electrical grid or a function thereof is less than the predetermined threshold indicative of the grid-induced power change,
wherein, by temporarily reducing the standard speed-related trip level for the certain time period, the GFM IBR has enough time to recover from the grid-induced power change and resume normal operation.

9. The method of claim 7, wherein the predetermined threshold ranges from about −0.1 Hertz per second (Hz/s) to about −1.0 Hz/s.

10. The method of claim 7, wherein the predetermined threshold is less than −1.0 Hz/s.

11. The method of claim 8, further comprising utilizing a trip counter to track a time period that the modified trip level is active.

12. The method of claim 11, further comprising increasing the modified trip level back to the standard speed-related trip level when the time period exceeds a certain time.

13. The method of claim 12, wherein the certain time ranges from about 5 seconds to about 30 seconds.

14. The method of claim 1, further comprising estimating the one or more grid frequency feedbacks using a phase-locked loop (PLL) of the GFM IBR and local feedback voltages.

15. The method of claim 1, wherein the GFM IBR is a double-fed or full-power conversion wind turbine generator in a wind turbine power system connected to the electrical grid, the double-fed wind turbine generator coupled to a power converter having a line-side converter and a rotor-side converter coupled together via a DC link.

16. A method of preventing grid frequency-induced trips of a grid-forming (GFM) inverter-based resource (IBR) connected to an electrical grid, the GFM IBR having a generator, the method comprising:
determining, via a controller, a rate of change of a grid frequency of the electrical grid based on one or more grid frequency feedbacks;
comparing, via the controller, the rate of change of the grid frequency to a predetermined threshold; and
temporarily increasing, via the controller, a standard speed-related trip level of the GFM IBR to a modified trip level for a certain time period when the rate of change of the grid frequency is greater than the predetermined threshold indicative of a grid-induced power change,
wherein, by temporarily increasing the standard speed-related trip level for the certain time period, the GFM IBR has enough time to recover from the grid-induced power change and resume normal operation.

17. The method of claim 16, further comprising estimating the one or more grid frequency feedbacks using a phase-locked loop (PLL) of the GFM IBR and local feedback voltages.

18. The method of claim 16, wherein determining the function of the grid frequency of the electrical grid based on the one or more grid frequency feedbacks further comprises:
utilizing a washout function to determine the rate of change of the grid frequency of the electrical grid based on the one or more grid frequency feedbacks; and
tuning the washout function to filter out noise but to retain enough bandwidth for an intended level of the rate of change of the grid frequency.

19. The method of claim 16, further comprising:
utilizing a trip counter to track a time period that the modified trip level is active; and
increasing the modified trip level back to the standard speed-related trip level when the time period exceeds a certain time.

20. A wind turbine power system connected to an electrical grid, comprising:
a tower;
a nacelle mounted atop the tower;
a rotor comprising a rotatable hub with at least one rotor blade; and
a controller for controlling the wind turbine power system, the controller comprising at least one processor, the at least one processor configured to perform a plurality of operations, the plurality of operations comprising:
determining a rate of change of a grid frequency of the electrical grid based on one or more grid frequency feedbacks;
comparing the rate of change of the grid frequency to a predetermined range indicative of a grid-induced power change of a certain amount; and
temporarily reducing a standard speed-related trip level of the wind turbine power system to a modified trip level for a certain time period when the rate of change of the grid frequency is outside of the predetermined range,
wherein, by temporarily reducing the standard speed-related trip level for the certain time period, the wind turbine power system has enough time to recover from the grid-induced power change and resume normal operation.
